(19) United States
(12) Patent Application Publication
(10) Pub. No.: US 2025/0165440 A1
(43) Pub. Date: May 22, 2025

(54) Mapping Disparate Database Schemas Using Artificial Intelligence

(71) Applicant: KPMG International Services Limited, Montvale, NJ (US)

(72) Inventors: Paul Medvedev, Montvale, NJ (US); Gavin Quertier, Montvale, NJ (US); Omair Masood, Montvale, NJ (US); Amit Depshpande, Montvale, NJ (US); Arnab Khan, Montvale, NJ (US)

(73) Assignee: KPMG International Services Limited, Montvale, NJ (US)

(21) Appl. No.: 18/954,586

(22) Filed: Nov. 21, 2024

Related U.S. Application Data
(60) Provisional application No. 63/601,775, filed on Nov. 22, 2023.

(51) Int. Cl. G06F 16/21; G06F 16/901

(52) U.S. Cl. CPC G06F 16/211; G06F 16/9024

(57) ABSTRACT

Systems, methods, and computer program products provide for mapping a source database schema to a destination database schema. Initially, a source database schema graph and a destination database schema graph are generated, each graph having a plurality of nodes, each node corresponding to a data object in the source database schema or the destination database schema. Graphical context data is then generated for the source database schema graph nodes and the destination database schema graph nodes. Using a trained artificial intelligence model, the graphical context data for a selected source database schema graph node is compared to the graphical context data for a selected destination database schema graph node, and a mapping between the selected source database schema graph node and the selected destination database schema graph node is labeled where the artificial intelligence model determines that the selected nodes are sufficiently similar.

### CROSS-REFERENCE TO RELATED APPLICATIONS

This application claims the benefit of U.S. Provisional Application No. 63/601,775 filed Nov. 22, 2023.

### TECHNICAL FIELD

The disclosed implementations relate generally to mapping data objects between different database schemas and, more specifically, to systems, computer-implemented methods, and user interfaces that provide artificial intelligence techniques for schema mapping.

### BACKGROUND OF THE INVENTION

The European System of Central Banks (ESCB) launched an initiative to standardize and harmonize bank data reporting with the objective of increasing efficiency or reporting and enhancing data quality. The initiative is called the Banks' Integrated Reporting Dictionary (BIRD) initiative. It is currently deployed on a voluntary basis although, when required, it will require banks to upload their prudential data onto one single repository instead of issuing reports. The BIRD initiative is not a database but rather a data model that can be implemented into a bank's internal data architecture or data warehouse.

Mapping client data models to BIRD is requires an exhaustive effort over hundreds of fields and SME hours to validate. By early 2027, Banks data will have to comply with the BIRD data model. In addition, clients are constantly facing the same problems: how does data match to other data or certain requirements?

At a high level, schema mapping provides a relationship between data objects of a one database (the “source” database) to corresponding data objects of another database (the “destination” database). The relationship may be one-to-one (only one source database and one destination database) or one-to-many (multiple source databases being mapped to a single destination database).

### SUMMARY OF THE INVENTION

In one aspect, a method is provided for mapping a source database schema to a destination database schema. The method includes generating a source database schema graph having a plurality of nodes, where each node corresponding to a data object in the source database schema. The method also includes generating graphical context data for the source database schema graph nodes and using a trained machine learning model to compare the graphical context data for a selected source database schema graph node to graphical context data for a selected destination database schema graph node. Where the machine learning model determines that the selected nodes are sufficiently similar a mapping between the selected source database schema graph node and the selected destination database schema graph node is labeled.

### BRIEF DESCRIPTION OF DRAWINGS

Embodiments of the invention are illustrated by way of example and not by way of limitation in the figures of the accompanying drawings.

FIG. 1 is a block diagram of a system for mapping between disparate database schemas;

FIG. 2 is a flowchart illustrating a method for mapping between disparate database schemas using the system of FIG. 1; and

FIG. 3 is a block diagram that illustrates a computer system upon which an embodiment of the invention may be implemented.

### DETAILED DESCRIPTION OF THE INVENTION

In the following description, details of embodiments of the invention are provided for the purposes of explanation and in order to provide a more thorough understanding. One or more embodiments may be practiced without these specific details. Features described in one embodiment may be combined with features described in a different embodiment.

In many situations, schema mapping requires matching schema attributes such as field names, table names, or data formats, of a source database and a destination database. A technical problem with known mapping processes, even when automated using scripting languages or the like, is that they require substantial manual intervention and supervision. Thus, not only is the mapping process laborious, but it also requires a high degree of precision and accuracy, neither being a notable aspect of human intervention. In many cases, the mapping process involves an in-depth understanding of the commercial and technical aspects of the two databases (or more if there are multiple source databases), the data stored therein, and the processes by which the data was generated. Even script-based mapping must often be reprogrammed to fit particularities of the source database, especially where, as with the BIRD initiative, the source databases will come from different entities with different data creation and storage priorities, meaning that known computer systems will be unable to both (a) map data between different schemas without substantial user interaction or reprogramming and (b) learn from mappings that are performed, i.e., form a feedback loop for enhanced performance and accuracy. As such, the invention disclosed here is a technical solution to the technical problem of how to enable automatically mapping two different database schemas to each other and continual improvement in performance that can be gained through artificial intelligence.

Embodiments of the invention provide a means for identifying analogs between corresponding tables in different databases using machine learning or a neural network formed generative AI. One or more fields in a table of one database may be identified as corresponding to one or more fields in a table of a different database. Such schema mapping may be used to integrate databases that are to be merged or to ensure compatibility with regulatory reporting requirements, such as those provided by the BIRD initiative.

Embodiments of the invention thus offer several benefits. In particular, embodiments of the invention use one or more AI models to reduce analysis and mapping time for large databases. The embodiments described herein represent an improvement to an existing technology or technologies, by providing specifical technologies that use pretrained AI models to classify large datasets of data of varying type and quality. Technologies do not currently exist for concurrently classifying data by AI and such that it can be mapped from one database to another. The embodiments described herein therefore do not merely recite the performance of some business practice known from the pre-computer world along with the requirement to perform it on a computer. Rather, these embodiments incorporate one or more AI models, whether generative AI or machine learning, to enable use of new or custom data, including aggregated or synthetic comparative data. Thus, the systems, methods, and computer-readable media are necessarily rooted in computer technology to overcome a problem specific to mapping the differing schemas of two databases (namely slow speed and varying accuracy due to contras). In addition, the present disclosure includes specific features other than what is well-understood, routine, convention activity in the field, or adding unconventional steps that confine the claim to a particular useful application, e.g., enabling further learning as feedback to enable more accurate mapping between the schemas, as described herein.

One or more embodiments utilize an artificial intelligence model (AI model) to generate a map from a source database schema (e.g., a bank database schema) to a destination database schema (e.g., the BIRD schema) based on graphical context data for source nodes in a graph of the source database schema and target nodes in a graph of the destination database schema. In some embodiments, the AI model is a machine learning model however, in other embodiments, the AI model is a generative AI model. Graphical context data for a given node represents relationships of the node to some (or all) of the other nodes in the respective source or destination graph. The AI model compares context data from nodes in the source graph to nodes in the destination graph to identify nodes that correspond to one another in the different graphs. The AI model then uses the identified correspondences to generate a map between fields of the source database schema to the destination database schema. The ability to use an AI model to map between the source and destination databases eliminates the need to manually intervene during the mapping process (one can simply wait to review the output) but also eliminates the need to reprogram a script due to different source database technologies.

Embodiments of the invention provide new technology benefits to the operation of a computer when compared with preexisting scripting techniques or manual intervention. For example, embodiments of the invention overcome the time and labor challenges by using an AI model. In some embodiments, a trained AI model analyzes the source and destination database schemas and renders each as n-dimensional graphs to improve the efficiency and accuracy when compared to previous computer-based analyses. Such an AI model may be used to identify source and destination database schema mappings using context data associated with each node in a graph. Context data describes the relationships between a particular node and some (or all) of the other nodes in a graph. The AI model can then use this context data to generate a mapping between one or more source databases and a destination database.

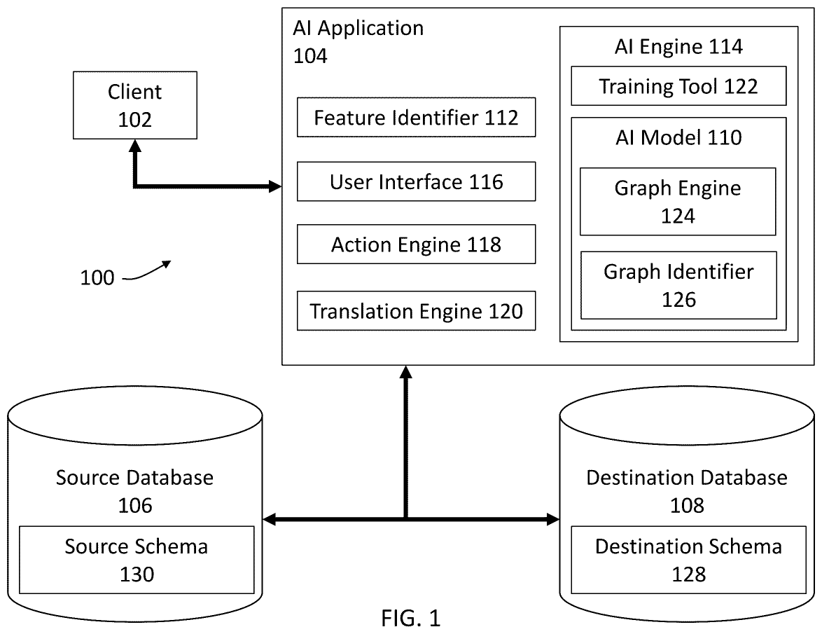

FIG. 1 is a block diagram of a system 100 for mapping between disparate database schemas. System 100 includes one or more client devices 102, a AI application 104, a source database 106, and a destination database 108. The components of system 100 may be implemented in hardware and/or software. Moreover, the components may be co-located or remote from each other and located in a single machine or distributed over multiple machines.

The client device 102 may be a mobile application, a web browser, or a computer application communicatively coupled to a network (not shown in FIG. 1). Moreover, the client device 102 may communicate with the other components of system 100 directly or via a cloud service using any suitable communication protocol, such as any Internet Protocol (IP). In some embodiments, the client device 102 is configured to receive and/or generate and send data items that are stored in one or both of the source and destination databases 106 and 108 and to transmit data to and receive data from the AI application 104. The client device 102 may also include a user interface that provides a graphical user interface (GUI) generated by the AI application 104. The GUI enable a user to start execution of schema mapping analyses and to view and/or classify training data for use by the AI application 104. Moreover, the client device 102 may also enable a user to provide feedback via the GUI related to the accuracy of the AI application 104 analysis or to cause the AI application 104 to restart a completed analysis, potentially using a different AI model than the original analysis.

The AI application 104 can be configured to train one or more AI models 110 using training data, to prepare destination schema graph data prior to, for example, ML analysis, and/or to analyze data to map a source database schema to the destination database schema. The AI application 104 includes a feature identifier 112, an AI engine 114, user interface generator 116, an action engine 118, and a translation engine 120.

The feature identifier 112 can be configured to identify characteristics associated with data objects in the source and destination databases 106 and 108. For example, the feature identifier 112 may identify attributes within training data that a trained AI model is directed to analyze. Once identified, the feature identifier 112 may identify those characteristics from a source database schema and tokenize the characteristics. The feature identifier 112 can then generate vectors that include a series of values, with each value representing a different characteristic token. As another example, the feature identifier 112 may identify attributes associated with data objects in a database schema, tokenize the attributes, and then generate one or more feature vectors that correspond to the data objects. In an embodiment, the feature identifier 112 may identify data objects associated with a database schema such as tables, array, fields, sets, fields, or other data objects, then identify attribute names, definitions, or descriptions within these data objects. These attributes can then be used to generate feature vectors. Notably, the feature vectors are stored and can be later used for further learning by the AI engine 114, acting as a feedback mechanism. This enables more accurate feature vectors to be generated by the feature identifier 112.

The AI engine 114 includes a training tool 122 and one or more AI models 110, which may be ML models or LLMs. The AI model 110 may include a graph engine 124 and a graph analyzer

126. In some embodiments, the training tool 122 receives training data as input, such as data objects associated with the destination database 108 and other training databases, and uses the training data to train the AI model 110. The AI model 110 may be any suitable type of machine learning model, such as a large language model (e.g., GPT-3 from OpenAI, LaMDA from Google, LLaMA from Meta, and the like), a graph neural network (GNN) model (e.g., PyTorch Geometric, Deep Graph Library, and the like), or a natural language processing (NLP) model. An embodiment is described below having a GNN model, however any suitable AI model can be used, and in some embodiments, the user can choose the preferred AI model for use in the analysis.

System 100 may train a GNN to recognize common language terms, either directly or using an NLP model. Once trained to recognize natural language, the GNN may then use NLP processing to interpret natural language aspects of data attributes within the source and destination schemas. The AI model 110 may be trained using a publicly available NLP dataset or an industry-specific NLP dataset. In some embodiments, training data used by the training tool 122 to train the AI engine 114 includes feature vectors of data items that are generated by the feature identifier 112. In some embodiments, the training tool 122 may access one or more training datasets that may be rendered as a graph for training purposes. A training graph may then be used to train a GNN. In other embodiments, a GNN may be trained in stages, first using a standard language dataset and an NLP application, then using additional datasets that are focused on a particular field (such as banking). The AI engine 114 may thus be trained using datasets associated with a destination database schema 128. Once trained, the AI engine 114 may be applied to the source database schema 130 to identify data objects within the source database schema 130 that are analogous to data objects within the destination database schema 128. Once the analogs are identified, the AI engine 114 may generate a mapping so that the source database schema 130 may be translated into the destination database schema 128. The mapping may be generated by the user interface component 116 for display by the client device 102 and/or stored as a data object itself. In an embodiment in which the mapping is stored, the AI model 110 can later use the stored mapping to compare against subsequent source-destination database pairs.

The AI model 110 is shown schematically in FIG. 1 as including a graph engine 124 and a graph identifier 126. The graph engine 124 receives a database schema, such as the source database schema 130, and converts the received schema into a graph representation. The AI model 110 analyzes the received schema data and identifies various attributes associated with the analyzed schema and/or the database objects of the analyzed schema. These attributes can then be used to identify schema objects and object relationships that are then used to render the schema as a graph. Some examples of attributes that can be identified and analyzed include entity names, entity definitions, entity descriptions, industry type, banking data, and other contextual data. Once the AI model 110 has analyzed the data, the graph engine 124 can use the analysis to generate the graph.

In some embodiments, the graph engine 124 can also generate context data for each node and/or edge in a graph representation of a schema. Context data can include identification of neighboring nodes, an indication of the distance between nodes, and/or an indication of relationship between nodes. Relationships between nodes can include an identification of intervening nodes, a number of intervening nodes, common fields with the intervening nodes, and so on.

The graph analyzer 126 can execute operations such as comparing a source database schema graph against a destination database schema graph. This identifies nodes in the destination database schema that are analogous to corresponding nodes in the source database schema. The graph analyzer 126 can identify these analogous nodes using context data to identify analogous source and destination nodes. For example, the graph analyzer 126 may accomplish this by identifying similar patterns of relationships to other nodes and/or by comparison of similar context data between nodes in the source and destination graphs. As another example, the graph analyzer 126 may perform an analysis that compares specific field and/or attribute values, such as an NLP analysis. The system 100 may use any combination of these techniques to identify nodes in the source and destination graphs as analogs.

In other embodiments of the invention, the GNN may be implemented using other types of AI models. For example, AI model 110 may include supervised and/or unsupervised ML algorithms. Alternatively, AI model 110 may include one or more of linear regression, logistic regression, linear discriminant analysis, classification and regression trees, k-nearest neighbors, learning vector quantization, support vector machine, back propagation, and/or clustering models. Moreover, in some embodiments, multiple trained AI models of the same or different types may be arranged in series such that the output of one model is processed by a subsequent model.

In various embodiments, the user interface 116 manages interactions between the client device 102 and the AI application 104. The user interface 116 may include hardware and/or software configured to facilitate communications between a user of the client device 102 and the AI application 104. For example, user interface 116 may process requests received from the client device 102 and translate results from other applications into a format that may be understood and processed by the client device 102 for presentation to the user. Specifically, the client device 102 may submit request to the AI application 104 via the user interface 116 to perform various functions, such as labeling training data, analyzing source and/or destination database schemas, or translating languages. User interface 116 may generate webpages and/or other GUI objects.

The action engine 118 may include an API, command line interface, or other interface for invoking functions by the AI application 104. These functions may be provided through a cloud service such that one or more components of the AI application 104 may invoke an API to access information stored in an external data repository for use as a training corpus for the AI engine 114.

The translation engine 120 can be used to translate from one language to another at the request of the user. For example, a source database schema may be provided in one written language, such as French, and required to be translated into a different language that matches the destination database schema, such as English. The translation engine 120 may use AI model 110 for this duty with supporting NLP processing algorithms.

In embodiments, source database 106 and destination database 108 may be stored on any type of storage unit or device or be spread across multiple storage units with cluster and/or failover effects. Moreover, source and destination databases 106 and 108 may be implemented or executed on the same computing system or different computing systems, on the same computing system as AI application 104, or on a different computing system as AI application 104 and communicatively coupled together. In the embodiment shown in FIG. 1, the source database 106 and destination database 108 each include respective schemas, source schema 130 and destination schema 128.

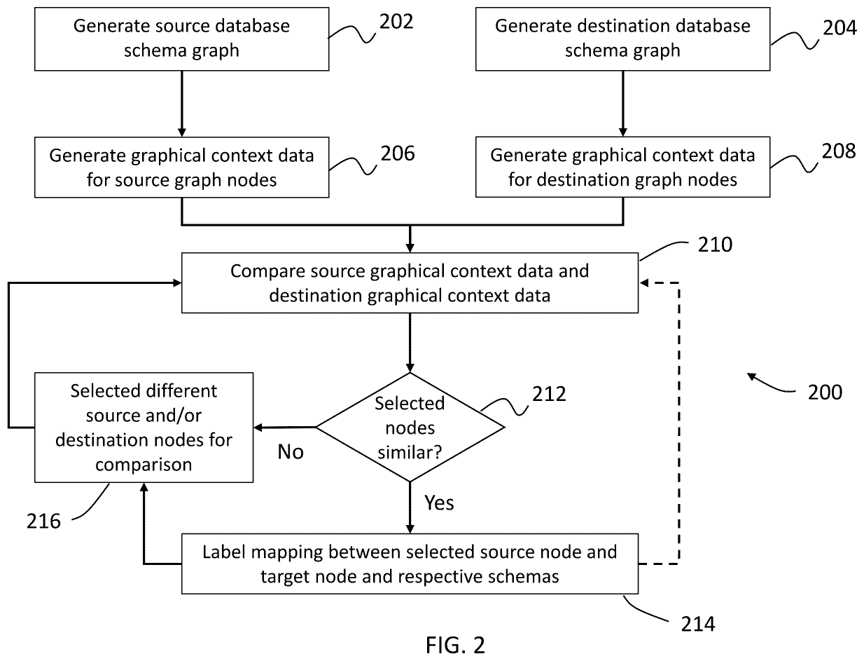

FIG. 2 is a flowchart illustrating a method 200 for mapping between disparate database schemas using the system 100 of FIG. 1. In an embodiment, a landing screen may be generated by the user interface 116 and presented to a user of the client device 102. The landing screen may include elements including previously uploaded and/or analyzed files in a grid view format. These previously analyzed files may have multiple statuses including Model Analysis Running, Failed, SME Analysis in Progress, or Analysis Completed. One or more of these statuses may be provided as a hyperlink that directs the user via the client device 102 and user interface 116 to a suggestion page. The landing page may also include other details about the previously uploaded files such as the entity that provided the file, the entity's client associated with the file, the origin language, a language model for use in translating from one language to another using the translation engine 120, the identity of the user who uploaded the file or a user identifier of that user, and a time and date stamp of when the file was uploaded.

In some embodiments, an upload interface enables the user to upload new files for analysis. If the user requires the input file to be translated using the translation engine 120, the user can also select the original and final languages in the upload interface. During the upload process, the file is checked for errors. If there is any error in the uploaded file, the error will be shown to the user for correction and reuploading. If no errors are detected, the file may be saved to the source database 106 and the analysis will run.

During the analysis, in steps 202 and 204, respectively, a source database schema graph and a destination database schema graph are generated. These steps may be performed in either order or simultaneously. Alternatively, the destination database schema graph may be generated once and referred to repeatedly thereafter for each new source database schema graph that is generated. The graphs may be generated using any of a number of techniques as described above. In an embodiment, feature identifier 112 may use a GNN or any other suitable AI algorithm to execute steps 202 and 204 by identifying objects of the source and destination database schemas using object identifiers. For example, the feature identifier 112 may use a GNN (or other trained AI model) may be trained to recognize textual patterns in the database schemas 128 and 130. The feature identifier 112, using a GNN (or other trained AI model), may also identify patterns or values within data stored in the data objects as a way of identifying relationships between the data objects. In another embodiment, the feature identifier 112, using a GNN (or other trained AI model), may use other attributes and/or combinations of attributes to uniquely identify data objects and relationships between data objects. Nodes of the graph representing the source database schema 130 may correspond to objects in the source database schema 130 and edges that connect those nodes may represent the relationships between the objects. The same is true of nodes and edges in the destination database schema 128. In some embodiments, the feature identifier 112 feeds the node and edge information to the AI model 110, specifically the graph engine 124, which generates the source and destination database schema graphs.

The graph analyzer 126 can then analyze the source and destination database schema graphs to generate graphical context data for the source graph and the destination graph in steps 206 and 208, respectively. As above, these steps may be performed in either order or simultaneously. Alternatively, the destination database schema graph may be generated once and referred to repeatedly thereafter for each new source database schema graph that is generated. The graph analyzer 126 generates and stores context data by analyzing the nodes and edges and the relationships between the nodes. The context data may be created for each node in each graph and may include data representations of the connections and relationships between the nodes of each graph.

Once the system 100 identifies the data objects of each schema 128 and 130, the system can begin the process of mapping the source schema 130 to the destination schema 128. In an embodiment, the AI model 110 compares 210 the context data for a selected node in the source graph to context data for a selected node in the destination graph. For example, the AI model 110 may initially compare attributes and/or attribute values of the selected nodes of the source and destination graphs, with the attributes and/or attribute values being present in the context data associate with the nodes. More specifically, the AI model 110 may compare key words associated with data objects and perform a similarity comparison on the key words. For example, the AI model 110 may detect that a primary key word for a data object in the source graph has a similarity score above a threshold value relative to a primary key word for a data object in the destination graph. One illustration of such a key word is “customer ID.” Because the system will identify these key words as similar, they can be associated together and the AI model 110 will label 214 the source and destination data objects as corresponding or matching. If the similarity threshold is not met, the AI model 110 can select 216 a different source and/or destination node for comparison. The comparison process continues until all nodes in the source graph are mapped to nodes in the destination graph.

In some embodiments, an output interface is provided to review the output of the AI model 110, which may be generated by the user interface 116 and presented to the user of the client device 102. For example, each data object in the source database schema 130 is provided with one or more suggested equivalent data objects in the destination database schema 128. Moreover, each suggestion may be provided with a confidence level, which may be generated by the AI model 110 as part of its comparison operation 210. The output interface may also be organized to display the field descriptions for the source database columns and the suggested (by the AI model 110) destination database columns. The AI model output can also be filtered by keywords to show only those descriptions with desired keywords or to filter out those descriptions with the desired keywords.

In one or more embodiments, a computer network provides connectivity among a set of nodes, which may be local to and/or remote from each other and connected by a set of links. A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

In an embodiment, various deployment models may be implemented by a computer network, including but not limited to a private cloud, a public cloud, and a hybrid cloud. In a private cloud, network resources are provisioned for exclusive use by a particular group of one or more entities, such as corporations, organizations, or people. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

Embodiments are directed to a system with one or more devices that include a hardware processor and that are configured to perform any of the operations described herein and/or recited in any of the claims below. In an embodiment, a non-transitory computer readable storage medium comprises instructions which, when executed by one or more hardware processors, causes performance of any of the operations described herein and/or recited in any of the claims. Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. In some examples a graphics processing unit (GPU) may be adapted to perform the methods described above. The special-purpose computing devices may be desk-top computer systems, portable computer systems, handheld devices, networking devices or any other device that incorporates hard-wired and/or program logic to implement the techniques.

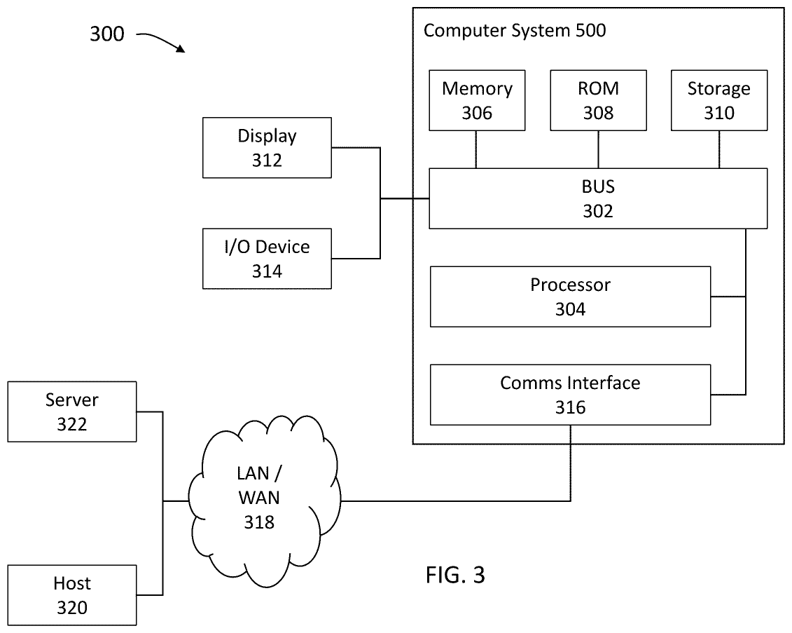

For example, FIG. 3 is a block diagram that illustrates a computer system 300 upon which an embodiment of the invention may be implemented. The computer system 300 includes a bus 302 or other communication mechanism for communicating information, and one or more hardware processors 304 coupled with the bus 302 for processing information. The processor 304 may be, for example, a general-purpose microprocessor. The computer system 300 also includes a memory 306, such as a random-access memory (RAM) or other dynamic storage device, coupled to the bus 302 for storing information and instructions to be executed by the processor 304. The memory 306 also may be used for storing temporary variables or other intermediate information during execution of instructions to be executed by the processor 304. Such instructions, when stored in non-transitory storage media accessible to the processor 304, render computer system 300 into a special-purpose machine that is customized to perform the operations specified in the instructions.

The computer system 300 further includes a read only memory (ROM) 308 or other static storage device coupled to the bus 302 for storing static information and instructions for the processor 304. A storage device 310, such as a magnetic disk or optical disk, is provided and coupled to the bus 302 for storing information and instructions. The computer system 300 may be coupled via the bus 302 to a display 312 for displaying information to a computer user. An input device 314, including alphanumeric and other keys, is coupled to the bus 302 for communicating information and command selections to processor the 304.

The computer system 300 may implement the techniques described herein using customized hard-wired logic, one or more ASICs or FPGAs, firmware and/or program logic which in combination with the computer system causes or programs the computer system 300 to be a special-purpose machine. According to one embodiment, the techniques herein are performed by computer system 300 in response to the processor 304 executing one or more sequences of one or more instructions contained in the memory 306. Such instructions may be read into the memory 306 from another storage medium, such as storage device 310. Execution of the sequences of instructions contained in the memory 306 causes the processor 304 to perform the process steps described herein. In alternative embodiments, hard-wired circuitry may be used in place of or in combination with software instructions. The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as the storage device 310. Volatile media includes dynamic memory, such as the memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-address-able memory (TCAM).

The computer system 300 also includes a communication interface 316 coupled to the bus 302. The communication interface 316 provides a two-way data communication coupling to a network link to a local and/or wide area network 318. For example, the communication interface 316 may be an integrated services digital network (ISDN) card, cable modem, satellite modem, or a modem to provide a data communication connection to a corresponding type of tele-phone line. As another example, the communication interface 316 may be a LAN card to provide a data communication connection to a compatible LAN. Wireless links may also be implemented. In any such implementation, the communication interface 316 sends and receives electrical, electromagnetic or optical signals that carry digital data streams representing various types of information. The network link typically provides data communication through one or more networks to other data devices. For example, the network link may provide a connection through the LAN/WAN 318 to a host computer 320 or through the Internet to a server 322. The host 320 and/or the server 322 may provide one or more functions of the embodiments described herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any of the functions disclosed herein may be implemented using means for performing those functions. Such means include, but are not limited to, any of the components or units disclosed herein, as well as known electronic and computing devices and associated components.

The techniques described herein may be implemented, for example, in hardware, one or more computer programs tangibly stored on one or more computer-readable media, firmware, hardware or any combination thereof. The techniques described herein may be implemented in one or more computer programs executing on (or executable by) a programmable computer or electronic device having any combination of any number of the following: a processor, a storage medium readable and/or writable by the processor (including, for example, volatile and non-volatile memory and/or storage elements), an input device, an output device, and a display. Program code may be applied to input entered using the input device to perform the functions described and to generate output using the output device.

Embodiments of the present invention include features which are only possible and/or feasible to implement with the use of one or more computers or servers, processors, and/or other elements of a computer or server system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which by implication or affirmatively require an electronic device such as a computer or server, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited electronic device or computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to determine the lineage of business terms and application interfaces between multiple software applications. There is no analog to this problem in the non-computer environment, nor is there an analog to the solutions disclosed herein in the non-computer environment. Furthermore, embodiments of the present invention represent improvements to computer and communication technology itself. For example, the system 100 of the present disclosure can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. Any data disclosed herein may be implemented, for example, in one or more data structures tangibly stored on a non-transitory computer-readable medium. Embodiments of the invention may store such data in such data structure(s) and read such data from such data structure(s).

1. A computer-implemented method for mapping a source database schema to a destination database schema, the method comprising:
generating a source database schema graph having a plurality of nodes, each node corresponding to a data object in the source database schema;
generating graphical context data for the source database schema graph nodes;
using a trained artificial intelligence (AI) model, comparing the graphical context data for a selected source database schema graph node to graphical context data for a selected destination database schema graph node; and
labeling a mapping between the selected source database schema graph node and the selected destination database schema graph node where the AI model determines that the selected nodes are sufficiently similar.

2. The computer-implemented method of claim 1, further comprising:
generating a destination database schema graph having a plurality of nodes, each node corresponding to a data object in the destination database schema; and
generating graphical context data for the destination database schema graph nodes.

3. The computer-implemented method of claim 1, further comprising, where the AI model determines that the selected nodes are not sufficiently similar:
selecting a second node from the source database schema graph;
using the AI model, comparing the graphical context data for the second source database schema graph node to graphical context data for the selected destination database schema graph node; and
labeling a mapping between the second source database schema graph node and the selected destination database schema graph node where the AI model determines that the selected nodes are sufficiently similar.

4. The computer-implemented method of claim 1, further comprising, where the AI model determines that the selected nodes are not sufficiently similar:
selecting a second node from the destination database schema graph;
using the AI model, comparing the graphical context data for the selected source database schema graph node to graphical context data for the second destination database schema graph node; and
labeling a mapping between the selected source database schema graph node and the second destination database schema graph node where the AI model determines that the selected nodes are sufficiently similar.

5. The computer-implemented method of claim 1, further comprising, where the AI model determines that the selected nodes are not sufficiently similar:
selecting a second node from the source database schema graph and a second node from the destination database schema graph;
using the AI model, comparing the graphical context data for the second source database schema graph node to graphical context data for the second destination database schema graph node; and
labeling a mapping between the second source database schema graph node and the second destination database schema graph node where the AI model determines that the selected nodes are sufficiently similar.

6. The computer-implemented method of claim 1, further comprising uploading a file containing the source database schema to a computer system.

7. The computer-implemented method of claim 1, further comprising translating the source database schema from a first language to a second language using a trained artificial intelligence (AI) model.

8. An apparatus for mapping a source database schema to a destination database schema, comprising:
one or more processors; and
memory storing instructions that, when executed by the one or more processors, cause the apparatus to:
generate a source database schema graph having a plurality of nodes, each node corresponding to a data object in the source database schema;
generate graphical context data for the source database schema graph nodes;
using a trained artificial intelligence (AI) model, compare the graphical context data for a selected source database schema graph node to graphical context data for a selected destination database schema graph node; and
label a mapping between the selected source database schema graph node and the selected destination database schema graph node where the AI model determines that the selected nodes are sufficiently similar.

9. The apparatus of claim 8, wherein the instructions, when executed by the one or more processors, further cause the apparatus to:
generate a destination database schema graph having a plurality of nodes, each node corresponding to a data object in the destination database schema; and
generate graphical context data for the destination database schema graph nodes.

10. The apparatus of claim 8, wherein, when the AI model determines that the selected nodes are not sufficiently similar, the instructions further cause the apparatus to:
select a second node from the source database schema graph;
use the AI model to compare the graphical context data for the second source database schema graph node to graphical context data for the selected destination database schema graph node; and
label a mapping between the second source database schema graph node and the selected destination database schema graph node where the AI model determines that the selected nodes are sufficiently similar.

11. The apparatus of claim 8, wherein, when the AI model determines that the selected nodes are not sufficiently similar, the instructions further cause the apparatus to:
select a second node from the destination database schema graph;
use the AI model to compare the graphical context data for the selected source database schema graph node to graphical context data for the second destination database schema graph node; and
label a mapping between the selected source database schema graph node and the second destination database schema graph node where the AI model determines that the selected nodes are sufficiently similar.

12. The apparatus of claim 8, wherein, when the AI model determines that the selected nodes are not sufficiently similar, the instructions further cause the apparatus to:
select a second node from the source database schema graph and a second node from the destination database schema graph;
use the AI model to compare the graphical context data for the second source database schema graph node to graphical context data for the second destination database schema graph node; and
label a mapping between the second source database schema graph node and the second destination database schema graph node where the AI model determines that the selected nodes are sufficiently similar.

13. The apparatus of claim 1, wherein the instructions further cause the apparatus to translate the source database schema from a first language to a second language using the AI model.

14. A computer-implemented system for mapping a source database schema to a destination database schema, comprising:
a feature identifier configured to identify attributes of the source database schema and destination database schema;
a graph engine configured to convert the identified attributes of the source database schema and destination database schema into respective graph representations; and
a graph analyzer configured to:
compare the graph representations to identify nodes in the destination database schema that are analogous to corresponding nodes in the source database schema; and
label as a match a mapping between selected source database schema graph nodes and corresponding destination database schema graph nodes where the graph analyzer determines that the nodes are sufficiently similar.

15. The computer-implemented system of claim 14, wherein the feature identifier is configured to identify the attributes of the source database schema and destination database schema, tokenize the attributes, and generate one or more feature vectors corresponding to the attributes.

16. The computer-implemented system of claim 14, further comprising a trained artificial intelligence (AI) model comprising the graph engine and the graph analyzer, wherein the AI model is configured to:
determine the relationship between selected source database schema graph nodes and corresponding destination database schema graph nodes; and
label as a match the mapping between selected source database schema graph nodes and corresponding destination database schema graph nodes where the AI model determines that the nodes are sufficiently similar.

17. The computer-implemented system of claim 14, wherein the graph engine is further configured to generate context data for each node in the respective graph representation of the source database schema and the destination database schema, and wherein the graph analyzer is configured to compare the context data of the nodes.

18. The computer-implemented system of claim 14, wherein the graph engine is further configured to generate context data for each edge between the nodes in the respective representation of the source database schema and the destination database schema, and wherein the graph analyzer is configured to compare the context data of the edges.
